(19) United States
(12) Patent Application Publication
(10) Pub. No.: US 2003/0229714 A1
(43) Pub. Date: Dec. 11, 2003

(54) Bandwidth management traffic-shaping cell

(75) Inventors: Frederick Kiremidjian, Danville, CA (US); Li-Ho Raymond Hou, Saratoga, CA (US)

Correspondence Address: LAW OFFICES OF THOMAS E. SCHATZEL, A Professional Corporation, Suite 240, 16400 Lark Avenue, Los Gatos, CA, 95032-2547, US

(73) Assignee: Amplify.Net, Inc.

(21) Appl. No.: 10/163,408

(22) Filed: Jun. 5, 2002

(51) Int. Cl. G06F 15/173

(52) U.S. Cl. 709/244

(57) ABSTRACT

A semiconductor integrated circuit chip comprises a class-based queue traffic shaper that enforces multiple service-level agreement policies on individual connection sessions by limiting the maximum data throughput for each connection. The class-based queue traffic shaper distinguishes amongst datapackets according to their respective source and/or destination IP-addresses. Each of the service-level agreement policies maintains a statistic that tracks how many datapackets are being buffered at any one instant. A test is made of each policy's statistic for each newly arriving datapacket. If the policy associated with the datapacket's destination indicates the agreed bandwidth limit has been reached, the datapacket is buffered and forwarded later when the bandwidth would not be exceeded.

### BACKGROUND OF THE INVENTION

1. Field of the Invention

The invention relates generally to computer network protocols and equipment for adjusting datapacket-by-datapacket bandwidth according to the source and/or destination IP-addresses of each such datapacket. More specifically, the present invention relates to a semiconductor integrated circuit for real-time control of network bandwidth.

2. Description of the Prior Art

Access bandwidth is important to Internet users. New cable, digital subscriber line (DSL), and wireless “always-on” broadband-access together are expected to eclipse dial-up Internet access in 2001. So network equipment vendors are scrambling to bring a new generation of broadband access solutions to market for their service-provider customers. These new systems support multiple high speed data, voice and streaming video Internet-protocol (IP) services, and not just over one access media, but over any media.

Flat-rate access fees for broadband connections will shortly disappear, as more subscribers with better equipment are able to really use all that bandwidth and the systems' overall bandwidth limits are reached. One of the major attractions of broadband technologies is that they offer a large Internet access pipe that enables a huge amount of information to be transmitted. Cable and fixed point wireless technologies have two important characteristics in common. Both are “fat pipes” that are not readily expandable, and they are designed to be shared by many subscribers.

Although DSL allocates a dedicated line to each subscriber, the bandwidth becomes “shared” at a system aggregation point. In other words, while the bandwidth pipe for all three technologies is “broad,” it is always “shared” at some point and the total bandwidth is not unlimited. All broadband pipes must therefore be carefully and efficiently managed.

Internet Protocol (IP) datapackets are conventionally treated as equals, and therein lies one of the major reasons for its “log jams”. When all IP-datapackets have equal right-of-way over the Internet, a “first come, first serve” service arrangement results. The overall response time and quality of delivery service is promised to be on a “best effort” basis only. Unfortunately all IP-datapackets are not equal, certain classes of IP-datapackets must be processed differently.

In the past, such traffic congestion has caused no fatal problems, only an increasing frustration from the unpredictable and sometimes gross delays. However, new applications use the Internet to send voice and streaming video IP-datapackets that mix-in with the data IP-datapackets. These new applications cannot tolerate a classless, best efforts delivery scheme, and include IP-telephony, pay-per-view movie delivery, radio broadcasts, cable modem (CM), and cable modem termination system (CMTS) over two-way transmission hybrid fiber/coax (HFC) cable.

Internet service providers (ISPs) need to be able to automatically and dynamically integrate service subscription orders and changes, e.g., for “on demand” services. Different classes of services must be offered at different price points and quality levels. Each subscriber's actual usage must be tracked so that their monthly bills can accurately track the service lines delivered. Each subscriber should be able to dynamically order any service based on time of day/week, or premier services that support merged data, voice and video over any access broadband media, and integrate them into a single point of contact for the subscriber.

There is an urgent demand from service providers for network equipment vendors to provide integrated broadband-access solutions that are reliable, scalable, and easy to use. These service providers also need to be able to manage and maintain ever growing numbers of subscribers.

Conventional IP-addresses, as used by the Internet, rely on four-byte hexadecimal numbers, e.g., 00H-FFH. These are typically expressed with four sets of decimal numbers that range 0-255 each, e.g., “192.55.0.1”. A single look-up table could be constructed for each of 4,294,967,296 (256⁴) possible IP-addresses to find what bandwidth policy should attach to a particular datapacket passing through. But with only one byte to record the policy for each IP-address, that approach would require more than four gigabytes of memory. So this is impractical.

There is also a very limited time available for the bandwidth classification system to classify a datapacket before the next datapacket arrives. The search routine to find which policy attaches to a particular IP-address must be finished within a finite time. And as the bandwidths get higher and higher, these search times get proportionally shorter.

The straight forward way to limit-check each node in a hierarchical network is to test whether passing a just received datapacket would exceed the policy bandwidth for that node. If yes, the datapacket is queued for delay. If no, a limit-check must be made to see if the aggregate of this node and all other daughter nodes would exceed the limits of a parent node. And then a grandparent node, and so on. Such sequential limit check of hierarchical nodes was practical in software implementations hosted on high performance hardware platforms. But it is impractical in a pure hardware implementation, e.g., a semiconductor integrated circuit.

### SUMMARY OF THE PRESENT INVENTION

It is therefore an object of the present invention to provide a semiconductor intellectual property for controlling network bandwidth at a local site according to a predetermined policy.

It is another object of the present invention to provide a semiconductor intellectual property that implements in hardware a traffic-shaping cell that can control network bandwidth at very high datapacket rates and in real time.

It is a further object of the present invention to provide a method for bandwidth traffic-shaping that can control network bandwidth at very high datapacket rates and still preserve datapacket order for each local destination.

Briefly, a chip embodiment of the present invention comprises a class-based queue traffic shaper that enforces multiple service-level agreement policies on individual connection sessions by limiting the maximum data throughput for each connection. The class-based queue traffic shaper distinguishes amongst datapackets according to their respective source and/or destination IP-addresses. Each of the service-level agreement policies maintains a statistic that tracks how many datapackets are being buffered at any one instant. A test is made of each policy's statistic for each newly arriving datapacket. If the policy associated with the datapacket's destination indicates the agreed bandwidth limit has been reached, the datapacket is buffered and forwarded later when the bandwidth would not be exceeded.

An advantage of the present invention is a device and method are provided for allocating bandwidth to network nodes according to a policy, and while preserving datapacket order to each destination.

A still further advantage of the present invention is a semiconductor intellectual property is provided that makes datapacket transfers according to service-level agreement policies in real time and at high datapacket rates.

These and many other objects and advantages of the present invention will no doubt become obvious to those of ordinary skill in the art after having read the following detailed description of the preferred embodiments which are illustrated in the drawing figures.

### IN THE DRAWINGS

FIG. 1 is a functional block diagram and dataflow diagram of a traffic-shaping cell (TSCELL) embodiment of the present invention;

FIG. 2 illustrates a network embodiment of the present invention;

FIG. 3 illustrates a class-based queue processing method embodiment of the present invention;

FIG. 4 is a bandwidth adjustment method embodiment of the present invention;

FIG. 5 is a datapacket process method embodiment of the present invention;

FIG. 6 illustrates a CBQ traffic shaper embodiment of the present invention;

FIG. 7 illustrates a datapacket receiver for receiving packets from a communications medium and placing them into memory;

FIG. 8 represents a hierarchical network embodiment of the present invention;

FIG. 9A illustrates a single queue and several entries;

FIG. 9B illustrates a few of the service line agreement policies included for use in FIGS. 8 and 9A;

FIG. 10 represents a bandwidth management system 1000 in an embodiment of the present invention; and

FIG. 11 represents a traffic shaping cell (TSCELL) 1100, in a semiconductor integrated circuit embodiment of the present invention.

### DETAILED DESCRIPTION OF THE PREFERRED EMBODIMENTS

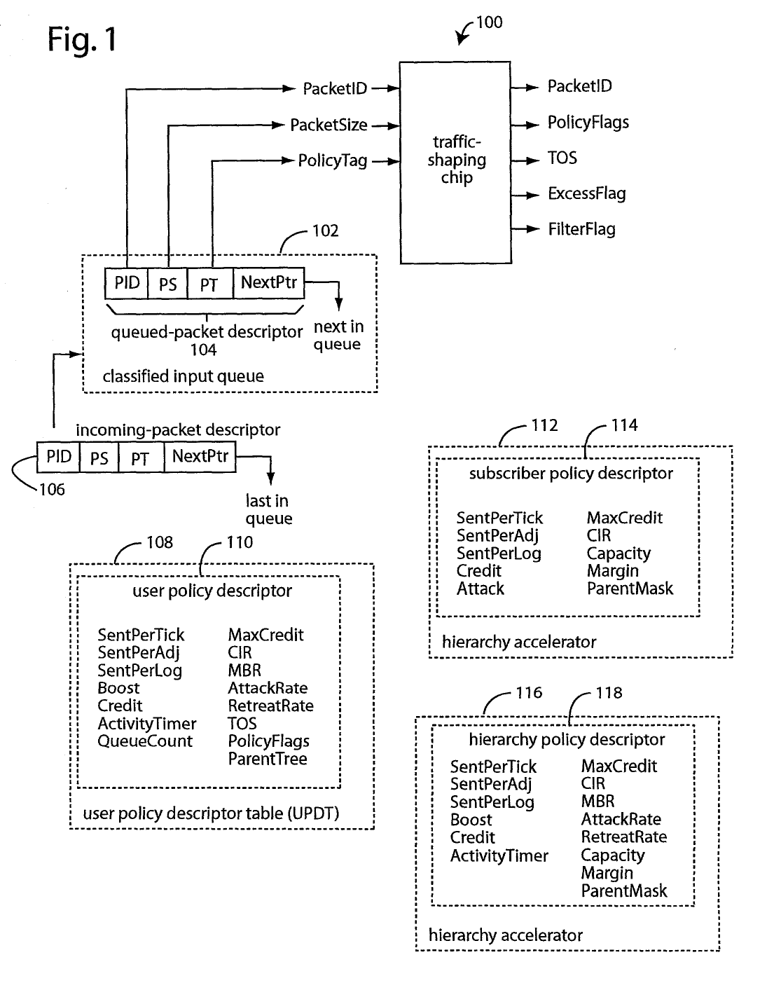

FIG. 1 represents a traffic-shaping cell (TSCELL) embodiment of the present invention, and is referred to herein by the general reference numeral 100. TSCELL 100 is preferably implemented as an intellectual property (IP) block, e.g., hardware description language, and is sold to third party manufacturers in Verilog-type computer storage files or similar IP formats. Semiconductor integrated circuit (IC) implementations TSCELL 100 are used to manage and shape available bandwidth allocated around a computer network. Such control is effectuated by limiting the rates that datapackets can be transferred according to subscriber service level agreement (SLA) policies. Users who pay for increased bandwidth, or users who have some other defined priority, are given a greater lion's share of the total bandwidth possible.

In operation, the TSCELL 100 does not directly control the flow of datapackets in a network. Instead, the datapackets are stored in buffers and datapacket descriptors are stored in queues. The datapacket descriptors include datapacket headers that provide information about the datapackets in the buffers. The TSCELL 100 processes these datapacket headers according to the SLA policies. A running account on each user is therefore necessary to manage the bandwidth actually delivered to each user in real-time.

Other, peripheral devices actually shuffle the datapackets into the buffers automatically and generate the datapacket descriptors. Such also look to the TSCELL 100 to see when an outgoing datapacket is to be released and sent along to its destination on the network.

As is the case with many computer-based devices, the TSCELL 100 can be implemented on general, programmable hardware as an executable program. It is, however, preferred here that the TSCELL 100 be implemented primarily in hardware. The advantage is speed of operation, but the disadvantages include the initial costs of design and tooling.

It was discovered that a hardware implementation of TSCELL 100 as a semiconductor chip is more practical if only a single queue is maintained for the datapackets. The present Assignee has recently filed several United States patent applications that discuss the use of this, and also embodiments with multiple queues. An application that describes the single queue usage is titled, VIRTUAL QUEUES IN A SINGLE QUEUE IN THE BANDWIDTH MANAGEMENT TRAFFIC-SHAPING CELL, Ser. No. 10/004,078, filed Nov. 27, 2001. Such application is incorporated herein by reference.

Referring again to FIG. 1, the TSCELL 100 takes as input a PacketID, a PacketSize, and a bandwidth PolicyTag. Such data comes from a classified input queue 102 which stores many queued-packet descriptors 104 in a linked list that is ordered by arrival time. The queued-packet descriptors 104 are preferably implemented as a four 32-bit words, e.g., 128-bits total. The PolicyTag can identify 20,000 different independent policies, or more. The internal links are implemented by a NextPtr. An incoming-packet descriptor 106 is added to the classified input queue 102 and links to the previously last queued-packet descriptor 104. The NextPtr's allow a rapid, ordered search to be made of all the queued-packet descriptors 104 in the classified input queue 102. The TSCELL 100 does a limit check which compares the size of each datapacket against all the bandwidth policies associated with all the network nodes it traverses to see if it can be forwarded along. A typical TSCELL 100 can accept upstream or downstream datapackets from as many as five gigabit Internet links, e.g., a 5.0 Gb/s bandwidth.

The TSCELL 100 is able to access a user policy descriptor table (UPDT) 108 that includes many different user policy descriptors 110. A hierarchy accelerator 112 is accessible to the TSCELL 100 and it includes a number of subscriber policy descriptors 114. Such hierarchy accelerator 112 is preferably implemented as a hardware structure. Another hierarchy accelerator 116 is also accessible to the TSCELL 100 and it includes a list of hierarchy policy descriptors 118.

Such descriptors 110, 114, and 118, allow the TSCELL to keep statistics on each node's actual bandwidth usage and to quickly reference the node's bandwidth management parameters. The ParentMask, in subscriber policy descriptors 114 and hierarchy policy descriptors 118, specifies the channel nodes to check for bandwidth adjustments in the subscriber nodes. There are typically sixty-four possible parent nodes for each subscriber node due to minimum memory size issues. For class nodes, ParentMask specifies the provider nodes to check for bandwidth adjustment. For provider nodes, ParentMask specifies the link nodes to check for bandwidth adjustment. For link nodes, ParentMask is not required and is set to zero.

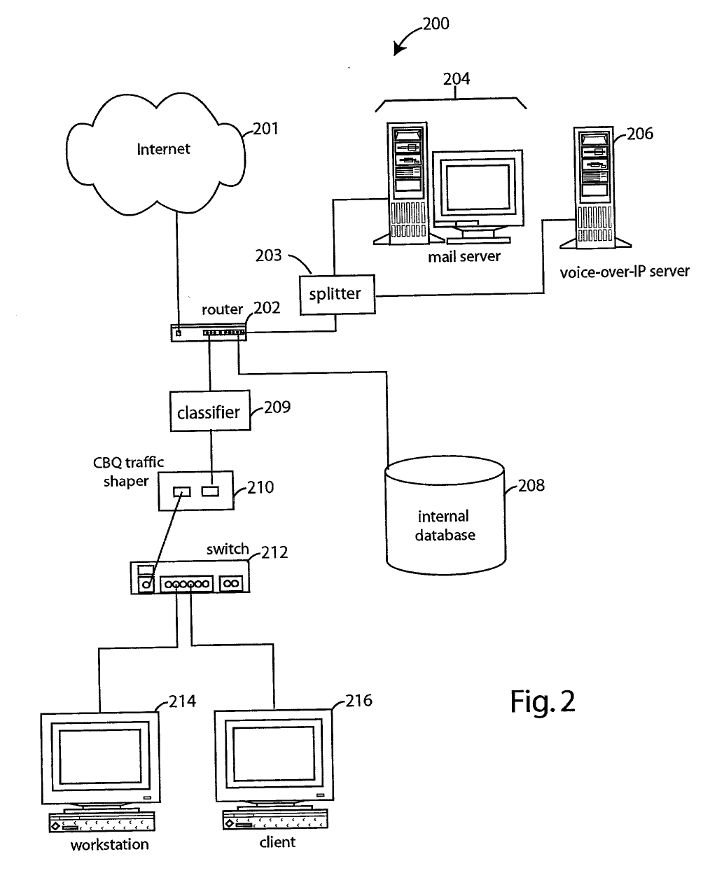

FIGS. 2-10 illustrate how TSCELL 100 can be applied in useful applications.

FIG. 2 illustrates a network embodiment of the present invention, and is referred to herein by the general reference numeral 200. The Internet 201 or other wide area network (WAN) is accessed through a network router 202. A bandwidth splitter 203 dynamically aggregates the demands for bandwidth presented by an e-mail server 204 and a voice-over-IP server 206 through the router 202. A local database 208 is included, e.g., to store e-mail and voice messages.

An IP-address/port-number classifier 209 monitors datapacket traffic passing through to the router 202, and looks into the content of messages to discern temporary address and port assignments being erected by a variety of application programs. A class-based queue (CBQ) traffic shaper 210 dynamically controls the maximum bandwidth for each connection through a switch 212 to any workstation 214 or any client 216. A similar control is included in splitter 203. The IP-address/port-number classifier 209 sends control packets over the network to the CBQ traffic shaper 210 that tell it what packets belong to what applications. Policies are used inside the CBQ traffic shaper 210 to monitor and limit every connection involving an IP-address behind the switch 212. A preferable exception is to allow any workstation 214 or any client 216 practically unlimited access bandwidth to their own local e-mail server 204 and voice-over-IP server 206. Such exception is handled as a policy override.

The separation of the IP-address/port-number classifier 209 and CBQ traffic shaper 210 into separate stand-alone devices allows independent parallel processors to be used in what can be a very processor-intensive job. Such separation further allows the inclusion of IP-address/port-number classifier 209 as an option for which an extra price can be charged. It could also be added in later as part of a performance upgrade. The datapacket communication between the IP-address/port-number classifier 209 and CBQ traffic shaper 210 allows some flexibility in the physical placement of the respective units and no special control wiring in between is necessary.

The policies are defined and input by a system administrator. Internal hardware and software are used to spool and despool datapacket streams through at the appropriate bandwidths. In business model implementations of the present invention, subscribers are charged various fees for different levels of service, e.g., better bandwidth and delivery time-slots. For example, the workstations 214 and clients 216 could be paying customers who have bought particular levels of Internet-access service and who have on-demand service needs. One such on-demand service could be the peculiar higher bandwidth and class priority needed to support an IP-telephone call. A use-fee or monthly subscription fee could be assessed to be able to make such a call.

If the connection between the WAN 201 and the router 202 is a digital subscriber line (DSL) or other asymmetric link, the CBQ traffic shaper 210 is preferred to have a means for enforcing different policies for the same local IP-addresses transmit and receive ports.

A network embodiment of the present invention comprises a local group of network workstations and clients with a set of corresponding local IP-addresses. Those local devices periodically need access to a wide area network (WAN). A class-based queue (CBQ) traffic shaper is disposed between the local group and the WAN, and provides for an enforcement of a plurality of service-level agreement (SLA) policies on individual connection sessions by limiting a maximum data throughput for each such connection. The class-based queue traffic shaper preferably distinguishes amongst voice-over-IP (voIP), streaming video, and datapackets. Any sessions involving a first type of datapacket can be limited to a different connection-bandwidth than another session-connection involving a second type of packet. The SLA policies are attached to each and every local IP-address, and any connection-combinations with outside IP-addresses can be ignored.

In alternative embodiments, the CBQ traffic shaper 210 is configured so that its SLA policies are such that any policy-conflicts between local IP-address transfers are resolved with a lower-speed one of the conflicting policies taking precedence. The CBQ traffic shaper is configured so its SLA policies are dynamically attached and readjusted to allow any particular on-demand content delivery to the local IP-addresses.

The data passed back and forth between connection partners during a session must be tracked by the CBQ traffic shaper 210 if it is to have all the information needed to classify packets by application. Various identifiable patterns will appear that will signal new information. These patterns are looked for by an IP-address/port-number classifier that monitors the datapacket exchanges. Such IP-address/port-number classifier is preferably included within the CBQ traffic shaper 210. An automatic bandwidth manager (ABM) is also included that controls the throughput bandwidth of each user by class assignment.

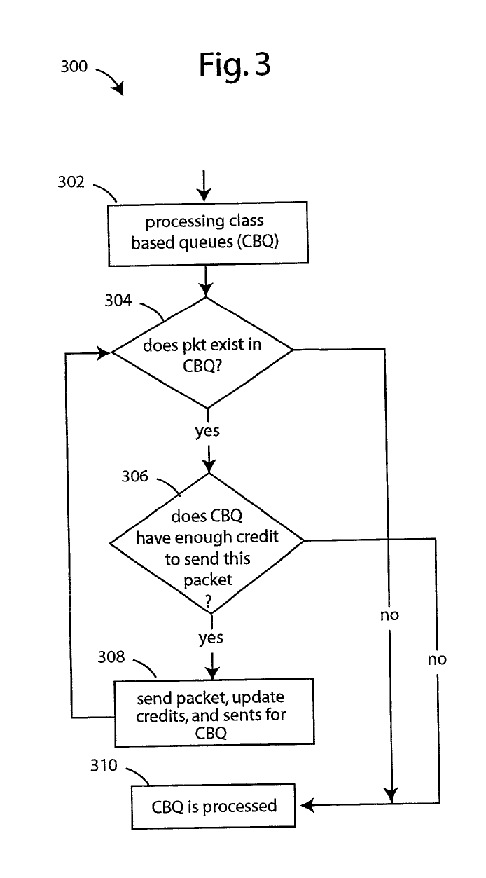

FIG. 3 illustrates a class-based queue processing method 300 that starts with a step 302. Such executes, typically, as a subroutine in the CBQ traffic shaper 110 of FIG. 1. A step 304 decides whether an incoming datapacket has a recognized class. If so, a step 306 checks that class currently has available bandwidth. If yes, a step 308 sends that datapacket on to its destination without detaining it in a buffer. Step 308 also deducts the bandwidth used from the class account, and updates other statistics. Step 308 returns to step 304 to process the next datapacket. Otherwise, a step 310 simply returns program control.

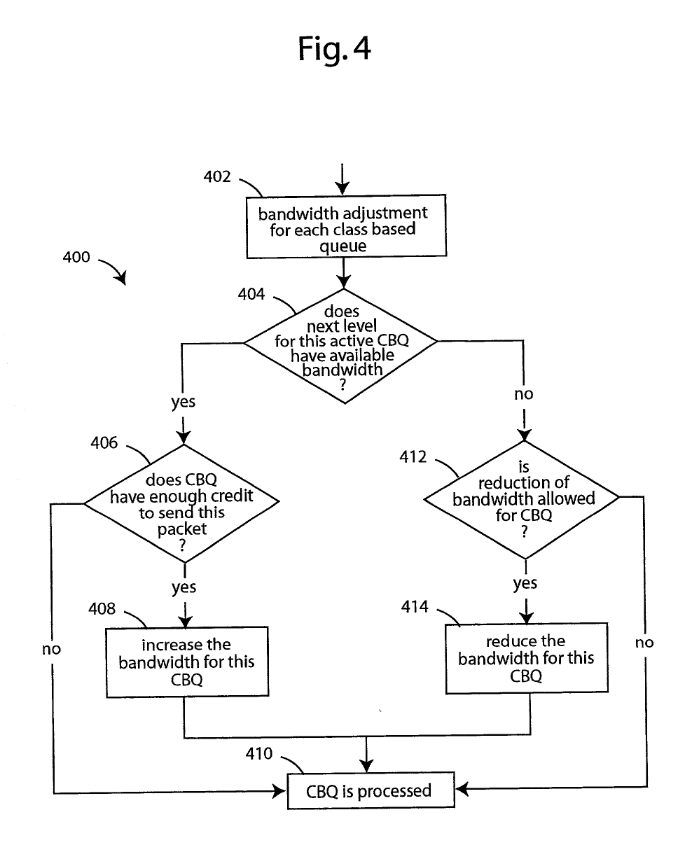

A bandwidth adjustment method 400 is represented by FIG. 4. It starts with a step 402. A step 404 decides if the next level for a current class-based queue (CBQ) has any available bandwidth that could be “borrowed”. If yes, a step 406 checks to see if the CBQ has enough “credit” to send the current datapacket. If yes, a step 408 temporarily increases the bandwidth ceiling for the CBQ and the current datapacket. A step 410 returns program control to the calling routine after the CBQ is processed. A step 412 is executed if there is no available bandwidth in the active CBQ. It checks to see if a reduction of bandwidth is allowed. If yes, a step 414 reduces the bandwidth.

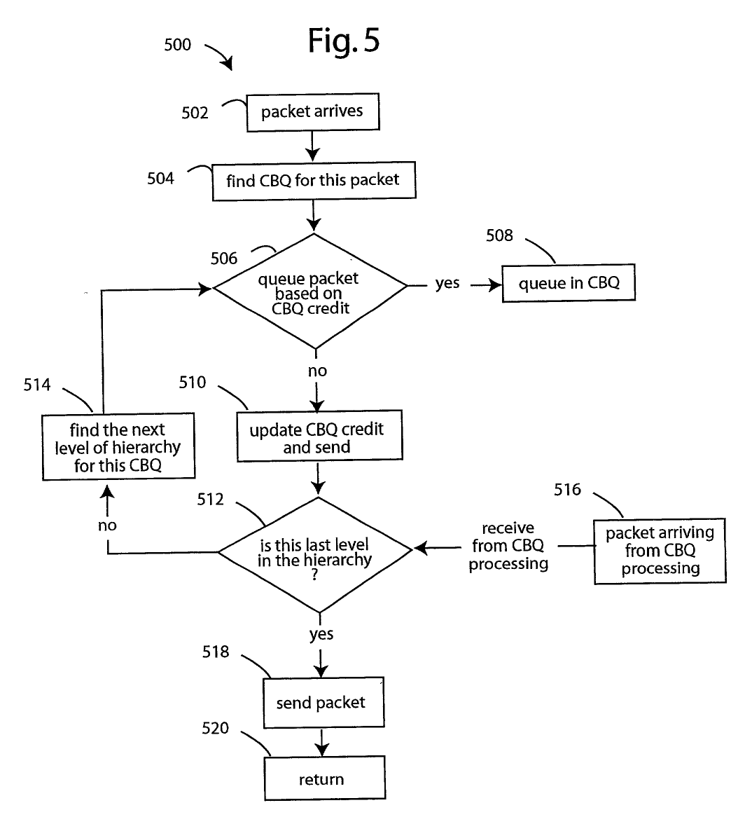

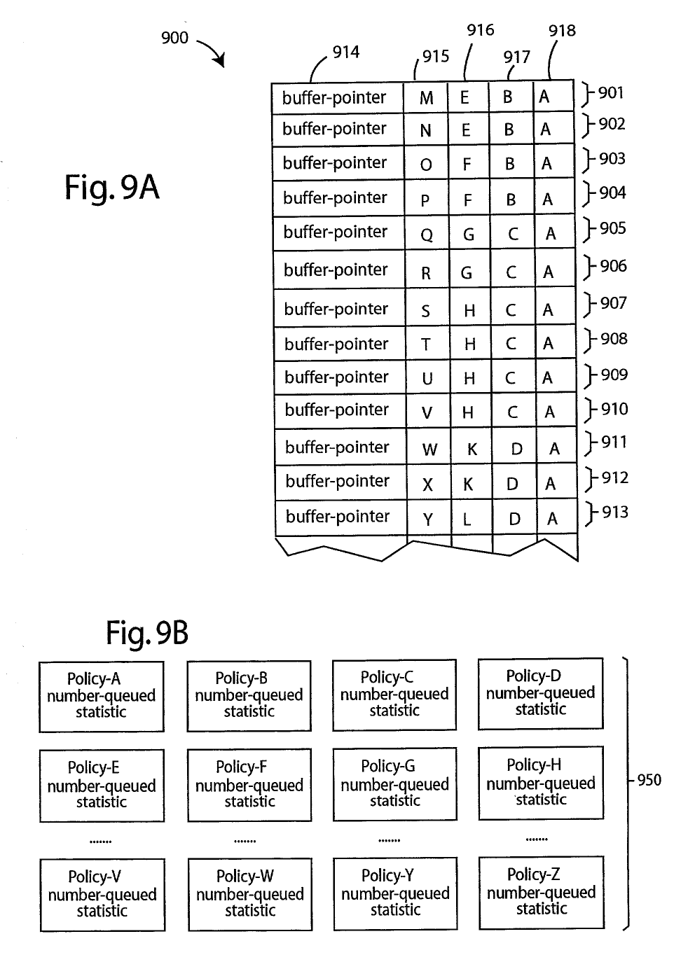

A datapacket process 500 is illustrated in FIG. 5 and is a method embodiment of the present invention. It begins with a step 502 when a datapacket arrives. A step 504 attempts to find a CBQ that is assigned to handle this particular class of datapacket. A step 506 checks to see if the datapacket should be queued based on CBQ credit. If yes, a step 508 queues the datapacket in an appropriate CBQ. Otherwise, a step 510 updates the CBQ credit and sends the datapacket. A step 512 checks to see if it is the last level in a hierarchy. If not, program control loops back through a step 514 that finds the next hierarchy level. A step 516 represents a return from a CBQ processing subroutine like that illustrated in FIG. 9. If the last level of the hierarchy is detected in step 512, then a step 518 sends the datapacket. A step 520 returns program control to the calling program.

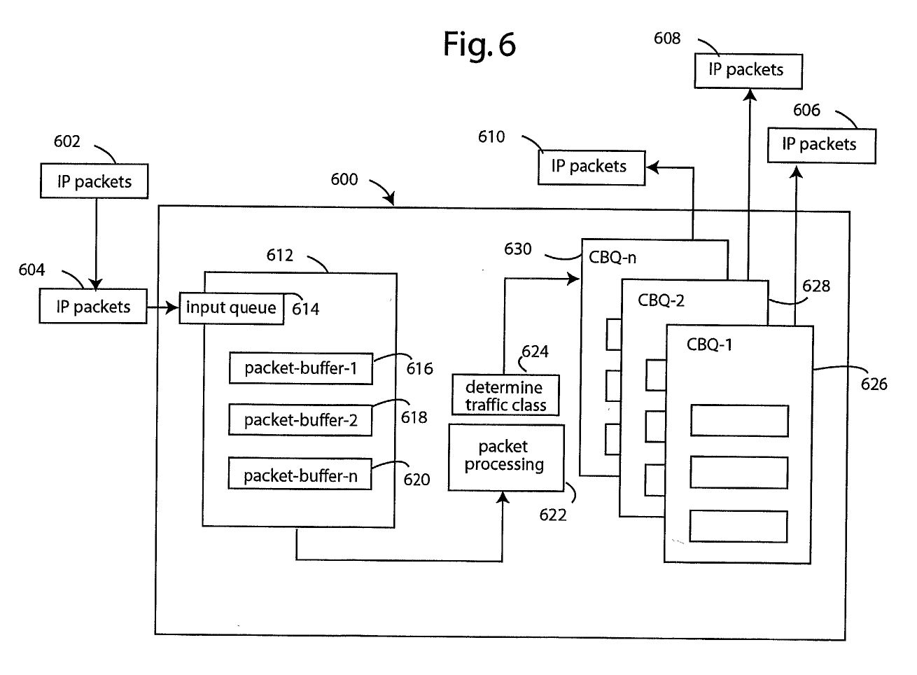

FIG. 6 illustrates a CBQ traffic shaper 600 in an embodiment of the present invention. The CBQ traffic shaper 600 receives an incoming stream of datapackets, e.g., 602 and 604. Such are typically transported with TCP/IP on a computer network like the Internet. Datapackets are output at controlled rates, e.g., as datapackets 606, 608, and 610. A typical CBQ traffic shaper 600 would have two mirror sides, one for incoming and one for outgoing for a full-duplex connection. Here in FIG. 6, only one side is shown and described to keep this disclosure simple and clear.

An IP-address/port-number classifier 612 has an input queue 614. It has several datapacket buffers, e.g., as represented by packet-buffers 616, 618, and 620. Each incoming datapacket is put in a buffer to wait for classification processing. A datapacket processor 622 and a traffic-class determining processor 624 distribute datapackets that have been classified and those that could not be classified into appropriate class-based queues (CBQ).

A collection of CBQs constitutes an automatic bandwidth manager (ABM). Such enforces the user service line agreement policies that attach to each class. Individual CBQs are represented in FIG. 6 by CBQ 626, 628, and 630. Each CBQ can be implemented with a first-in, first-out (FIFO) register that is clocked at the maximum allowable rate (bandwidth) for the corresponding class.

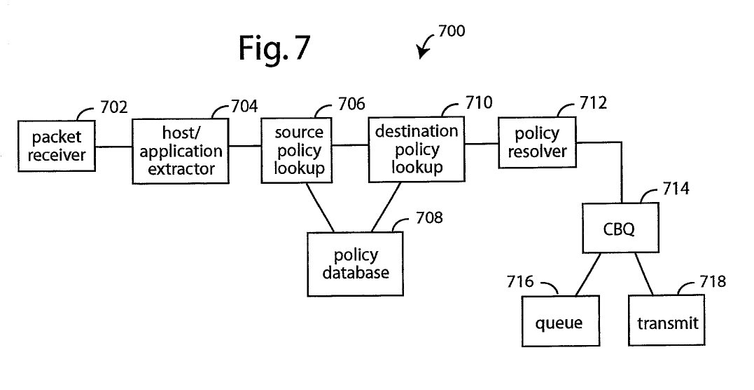

FIG. 7 illustrates a datapacket receiver 702 for receiving packets from a communications medium and placing them into memory. A host/application extractor 704 inspects the datapacket the host/application combinations for both the source and destination hosts. This information is passed onto a source policy lookup block 706 that takes the source host/application combination and looks for an associated policy, using a policy database 708. A destination policy lookup block 710 uses the destination host/application combination and looks for an associated policy. A policy resolver 712 uses the source policy and/or destination policies, if any, to resolves conflicts.

The policy resolver 712 accepts the one policy if only one is available, either source or destination. If both the source and destination have policies, and one policy is an “override” policy, then the “override” policy is used. If both source and destination each have their own independent policies, but neither policy is an override policy, then the more restrictive policy of the two is implemented. If both source and destination have a policy, and both policies are override policies, then the more restrictive policy of the two is used.

A class based queuing module 714 loads the policy chosen by the policy resolver 712 and applies it to the datapacket passing through. The result is a decision to either queue the datapacket or transmit it immediately. A queue 716 is used to store the datapacket for later transmission, and a transmitter 718 sends the datapacket immediately.

In general, a network embodiment of the present invention comprises a local group of network workstations and clients with a set of corresponding local IP-addresses. These periodically need access to a wide area network (WAN). A class-based queue (CBQ) traffic shaper is disposed between the local group and the WAN, and provides for an enforcement of a plurality of service-level agreement (SLA) policies on individual connection sessions by limiting a maximum data throughput for each such connection. An override mechanism may be included in at least one of said plurality of SLA policies for resolution conflicts between SLA policies in the CBQ traffic shaper. The one SLA policy with override set takes priority. Such override mechanism is unnecessary in configurations where there are not any VoIP, video or other high bandwidth servers that depend on being able to grab extra bandwidth.

In the absence of override or rank contests, conflicts are resolved in favor of the lower speed policy.

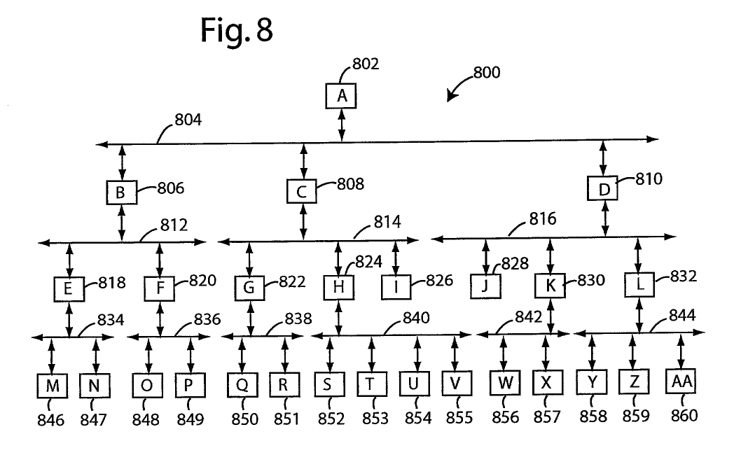

FIG. 8 represents a hierarchical network embodiment of the present invention, and is referred to herein by the general reference numeral 800. The network 800 has a hierarchy that is common in cable network systems. Each higher level node and each higher level network is capable of data bandwidths much greater than those below it. But if all lower level nodes and networks were running at maximum bandwidth, their aggregate bandwidth demands would exceed the higher-level's capabilities.

The network 800 therefore includes bandwidth management that limits the bandwidth made available to daughter nodes, e.g., according to a paid service-level agreement policy. Higher bandwidth policies are charged higher access rates. Even so, when the demands on all the parts of a branch exceed the policy for the whole branch, the lower-level demands are trimmed back. For example, to keep one branch from dominating trunk-bandwidth to the chagrin of its peer branches.

The present Assignee, Amplify.net, Inc., has filed several United States patent applications that describe such service-level agreement policies and the mechanisms to implement them. Such include: INTERNET USER-BANDWIDTH MANAGEMENT AND CONTROL TOOL, now U.S. Pat. No. 6,085,241, issued Jul. 4, 2000; BANDWIDTH SCALING DEVICE, Ser. No. 08/995,091, filed Dec. 19, 1997; BANDWIDTH ASSIGNMENT HIERARCHY BASED ON BOTTOM-UP DEMANDS, Ser. No. 09/718,296, filed Nov. 21, 2000; NETWORK-BANDWIDTH ALLOCATION WITH CONFLICT RESOLUTION FOR OVERRIDE, RANK, AND SPECIAL APPLICATION SUPPORT, Ser. No. 09/716,082, filed Nov. 16, 2000; GRAPHICAL USER INTERFACE FOR DYNAMIC VIEWING OF PACKET EXCHANGES OVER COMPUTER NETWORKS, Ser. No. 09/729,733, filed Dec. 4, 2000; ALLOCATION OF NETWORK BANDWIDTH ACCORDING TO NETWORK APPLICATION, Ser. No. 09/718,297, filed Nov. 21, 2000; METHOD FOR ASCERTAINING NETWORK BANDWIDTH ALLOCATION POLICY ASSOCIATED WITH APPLICATION PORT NUMBERS, Ser. No. 09/922,107, filed Aug. 2, 2001; and METHOD FOR ASCERTAINING NETWORK BANDWIDTH ALLOCATION POLICY ASSOCIATED WITH NETWORK ADDRESS, Ser. No. 09/924,198, filed Aug. 7, 2001. All of which are incorporated herein by reference.

Suppose the network 800 represents a city-wide cable network distribution system. A top trunk 802 provides a broadband gateway to the Internet and it services a top main trunk 804, e.g., having a maximum bandwidth of 100-Mbps. At the next lower level, a set of cable modem termination systems (CMTS) 806, 808, and 810, each classifies traffic into data, voice and video 812, 814, and 816. If each of these had bandwidths of 45-Mbps, then all three running at maximum would need 135-Mbps at top main trunk 804 and top gateway 802. A policy-enforcement mechanism is included that limits, e.g., each CMTS 806, 808, and 810 to 45-Mbps and the top Internet trunk 802 to 100-Mbps. If all traffic passes through the top Internet trunk 802, such policy-enforcement mechanism can be implemented there alone.

Each CMTS supports multiple radio frequency (RF) channels 818, 820, 822, 824, 826, 828, 830, and 832, which are limited to a still lower bandwidth, e.g., 38-Mbps each. A group of neighborhood networks 834, 836, 838, 840, 842, and 844, distribute bandwidth to end-users 846-860, e.g., individual cable network subscribers residing along neighborhood streets. Each of these could buy 5-Mbps bandwidth service level agreement policies, for example,

Each node can maintain a management queue to control traffic passing through it. Several such queues can be collectively managed by a single controller, and a hierarchical network would ordinarily require the several queues to be dealt with sequentially. Here, such several queues are collapsed into a single queue that is checked broadside in a single clock.

But single queue implementations require an additional mechanism to maintain the correct sequence of datapackets released by a traffic shaping manager, e.g., a TSCELL like TSCELL 100 in FIG. 1. When a new datapacket arrives the user nodes and parent nodes are indexed to draw out the corresponding service-level agreement policies.

For example, suppose a previously received datapacket for a user node was queued because there were not enough bandwidth credits to send it through immediately. Then a new datapacket for the same user node arrives just as the TSCELL finishes its periodical credit replenishment process. Ordinarily, a check of bandwidth credits here would find some available, and so the new datapacket would be forwarded. But, out of sequence because the earlier datapacket was still in the queue. It could further develop that the datapacket still in the queue would continue to find a shortage of bandwidth credits and be held in the buffer even longer.

The better policy, as used in embodiments of the present invention, is to hold newly arriving datapackets for a user node if any previously received datapackets for that user node are in the queue. In a single queue implementation then, the challenge is in constructing a mechanism for the TSCELL to detect whether there are other datapackets that belong to the same user nodes that are being queued.

Embodiments of the present invention use a virtual queue count for each user node. Each user node includes a virtual queue count that accumulates the number of datapackets currently queued in the single queue due to lack of available credit in the user node or in one of the parent nodes. When a datapacket is queued, a TSCELL increments such count by one. When a datapacket is released from the queue, the count is decremented by one. Therefore, when a new datapacket arrives, if the queued-datapacket count is not zero, the datapacket is queued. This, without trying the parallel limit checking. Such maintains a correct datapacket sequence and it saves processing time.

The TSCELL periodically scans the single queue to check if any of the queued datapacket can be released, e.g., because new credits have been replenished to node data structure. If a queued datapacket for a user node still lacks credits at any one of the corresponding nodes, then other datapackets for the user node in a subsequent scan will not be released if the datapacket will be released out of sequence, even if that datapacket has enough bandwidth credit itself to be sent.

Embodiments of the present invention can use a “scan flag” in each user node. The TSCELL typically resets all flags in every user node before the queue scan starts. It sets a flag when it processes a queued datapacket and the determination is made to continue it in the queue. When the TSCELL processes a datapacket, it first uses the pointer to the user node in the queue entry to check if the flag is set or not. If it is set, then it does not need to do a parallel limit check, and just skips to the next entry in the queue. If the flag is not set, it then checks if a queued datapacket can be released.

Some embodiments of the present invention combine a virtual queue count and a scan flag, e.g., a virtual queue flag. Just like the scan flag, the virtual queue flag is reset before the TSCELL starts a new scan. The virtual queue flag is set when a queued datapacket is scanned and the result is continued queuing. During the scan, if the virtual queue flag corresponding to the user node of the queued entry is already set, the queued entry is skipped without performing a parallel limit check. When a new datapacket arrives in between two scans, it also uses such virtual queue flag to determine whether it needs to do a parallel limit check. If the flag is set, the newly arrived datapacket is queued automatically without a limit check. When a parallel limit check is performed and the result is queuing the datapacket, the flag is set by the TSCELL. When a new datapacket arrives during a queue scan by the TSCELL, the newly arrived datapackets will be queued automatically and they are processed by the queue scan which is already in progress. This mechanism prevents out of order datapacket release because the virtual queue flag is reset at the beginning of the scan and the scan is not finished yet. If there is no datapacket in the queue and the queue scan reaches this new datapacket, the parallel check will be done to determine whether it should be released.

The integration of class-based queues and datapacket classification mechanisms in semiconductor chips necessitates more efficient implementations, especially where bandwidths are exceedingly high and the time to classify and policy-check each datapacket is exceedingly short. Therefore, embodiments of the present invention describes a new approach which manages every datapacket in the whole network 800 from a single queue. Rather, as in previous embodiments, than maintaining queues for each node A-Z, and AA, and checking the bandwidth limit of all hierarchical nodes at all four levels in a sequential manner to see if a datapacket should be held or forwarded. Embodiments of the present invention manage every datapacket through every node in the network with one single queue and checks the bandwidth limit at relevant hierarchical nodes simultaneously in a parallel architecture.

Each entry in the single queue includes fields for the pointer to the present source or destination node (user node), and all higher level nodes (parent nodes). The bandwidth limit of every node pointed to by this entry is tested in one clock cycle in parallel to see if enough credit exists at each node level to pass the datapacket along.

FIG. 9A illustrates a single queue 900 and several entries 901-913. A first entry 901 is associated with a datapacket sourced from or destined for subscriber node (M) 846. If such datapacket needs to climb the hierarchy of network 800 (FIG. 8) to access the Internet, the service level agreement policies of the user node (M) 846 and parent nodes (E) 818, (B) 806 and (A) 802 will all be involved in the decision whether or not to forward the datapacket or delay it. Similarly, another entry 912 is associated with a datapacket sourced from or destined for subscriber node (X) 857. If such datapacket also needs to climb the hierarchy of network 800 (FIG. 8) to access the Internet, the service level agreement policies of nodes (X) 857, (K) 830, (D) 810 and (A) 802 will all be involved in the decision whether or not to forward such datapacket or delay it.

There are many ways to implement the queue 900 and the fields included in each entry 901-913. The instance of FIG. 9 is merely exemplary. A buffer-pointer field 914 points to where the actual data for the datapacket resides in a buffer memory, so that the queue 900 doesn't have to spend time and resources shuffling the whole datapacket header and payload around. A credit field 915-918 is divided into four subfields that represent the four possible levels of the hierarchy for each subscriber node 846-160 or nodes 826 and 828.

A calculation periodically deposits credits in each four sub-credit fields to indicate the availability of bandwidth, e.g., one credit for enough bandwidth to transfer one byte of data through the respective node. The byte-credit needs to be compared with the packet size. When a decision is made to either forward or hold a datapacket represented by each corresponding entry 901-913, the credit field 917 is inspected. If all subfields indicate a credit and are larger than the datapacket size, then the respective datapacket is forwarded through the network 800 and the entry cleared from queue 900. The consumption of the credit is reflected by decrement the byte count of the packet size for each involved subfield. For example, if the inspection of entry 901 resulted in the respective datapacket being forwarded, the credits for nodes M, E, B, and A would all be decremented for entries 902-913. This may result in zero credits for entry 902 at the E, B, or A levels. If so, the corresponding datapacket for entry 902 would be held.

The single queue 900 also prevents datapackets from-or-to particular nodes from being passed along out of order. The TCP/IP protocol allows and expects datapackets to arrive in random order, but network performance and reliability is best if datapacket order is preserved.

The service-level agreement policies are defined and input by a system administrator. Internal hardware and software are used to spool and despool datapacket streams through at the appropriate bandwidths. In business model implementations of the present invention, subscribers are charged various fees for different levels of service, e.g., better bandwidth and delivery time-slots.

A network embodiment of the present invention comprises a local group of network workstations and clients with a set of corresponding local IP-addresses. Those local devices periodically need access to a wide area network (WAN). A class-based queue (CBQ) traffic shaper is disposed between the local group and the WAN, and provides for an enforcement of a plurality of service-level agreement (SLA) policies on individual connection sessions by limiting a maximum data throughput for each such connection. The class-based queue traffic shaper preferably distinguishes amongst voice-over-IP (voIP), streaming video, and datapackets. Any sessions involving a first type of datapacket can be limited to a different connection-bandwidth than another session-connection involving a second type of datapacket. The SLA policies are attached to each and every local IP-address, and any connection-combinations with outside IP-addresses can be ignored.

FIG. 9B illustrates a few of the service line agreement policies 950 included for use in FIGS. 8 and 9A. Each policy maintains a statistic related to how many datapackets are being buffered for a corresponding network node, e.g., A-Z and AA. A method embodiment of the present invention classifies all newly arriving datapackets according to which network nodes they must pass and the corresponding service-level agreement policies involved. Each service-level agreement policy statistic is consulted to see if any datapackets are being buffered, e.g., to delay delivery to the destination to keep the network-node bandwidth within service agreement levels. If there is even one such datapacket being held in the buffer, then the newly arriving datapacket is sent to the buffer too. This occurs without regard to whether enough bandwidth-allocation credits currently exist to otherwise pass the datapacket through. The objective here is to guarantee that the earliest arriving datapackets being held in the buffer will be delivered first. When enough “credits” are collected to send the earliest datapacket in the queue, it is sent even before smaller but later arriving datapackets.

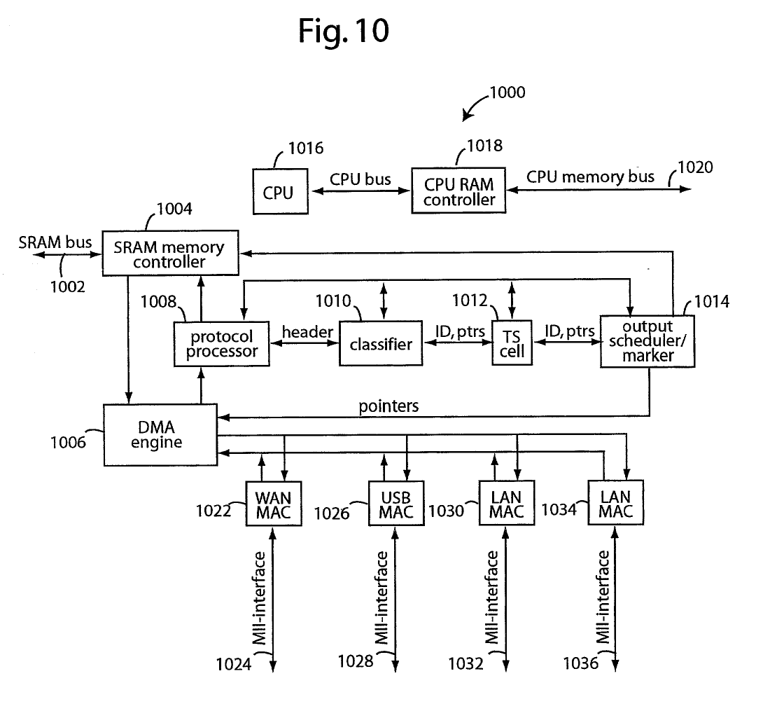

FIG. 10 represents a bandwidth management system 1000 in an embodiment of the present invention. The bandwidth management system 1000 is preferably implemented in semiconductor integrated circuits (IC's). The bandwidth management system 1000 comprises a static random access memory (SRAM) bus 1002 connected to an SRAM memory controller 1004. A direct memory access (DMA) engine 1006 helps move blocks of memory in and out of an external SRAM array. A protocol processor 1008 parses application protocol to identify the dynamically assigned TCP/UDP port number then communicates datapacket header information with a datapacket classifier 1010. Datapacket identification and pointers to the corresponding service level agreement policy are exchanged with a traffic shaping (TS) cell 1012 implemented as a single chip or synthesizable semiconductor intellectual property (SIA) core. Such datapacket identification and pointers to policy are also exchanged with an output scheduler and marker 1014. A microcomputer (CPU) 1016 directs the overall activity of the bandwidth management system 1000, and is connected to a CPU RAM memory controller 1018 and a RAM memory bus 1020. External RAM memory is used for execution of programs and data for the CPU 1016. The external SRAM array is used to shuffle the network datapackets through according to the appropriate service line agreement policies.

The datapacket classifier 1010 first identifies the end-user service level agreement policy, e.g., the policy associated with nodes 846-860. Every end-user policy also has its corresponding policies associated with all parent nodes of this user node. The classifier passes an entry that contains a pointer to the datapacket itself that resides in the external SRAM and the pointers to all corresponding nodes for this datapacket, i.e. the user nodes and its parent node. Each node contains the service level agreement policies such as bandwidth limit (CR and MBR) and the current available credit for a datapacket to go through.

A variety of network interfaces can be accommodated, either one type at a time, or many types in parallel. When in parallel, the protocol processor 1008 aids in translations between protocols, e.g., USB and TCP/IP. For example, a wide area network (WAN) media access controller (MAC) 1022 presents a media independent interface (MII) 1024, e.g., 100BaseT fast Ethernet. A universal serial bus (USB) MAC 1026 presents a media independent interface (MII) 1028, e.g., using a USB-2.0 core. A local area network (LAN) MAC 1030 has an MII connection 1032. A second LAN MAC 1034 also presents an MII connection 1036. Other protocol and interface types include home phone-line network alliance (HPNA) network, IEEE-802.11 wireless, etc. Datapackets are received on their respective networks, classified, and either sent along to their destination or stored in SRAM to effectuate bandwidth limits at various nodes, e.g., “traffic shaping”.

The protocol processor 1008 is implemented as a table-driven state engine, with as many as two hundred and fifty-six concurrent sessions and sixty-four states. The die size for such an IC is currently estimated at 20.00 square millimeters using 0.18 micron CMOS technology. Alternative implementations may control 20,000 or more independent policies, e.g., community cable access system.

The classifier 1010 preferably manages as many as two hundred and fifty-six policies using IP-address, MAC-address, port-number, and handle classification parameters. Content addressable memory (CAM) can be used in a good design implementation. The die size for such an IC is currently estimated at 10.91 square millimeters using 0.18 micron CMOS technology.

The traffic shaping (TS) cell 1012 preferably manages as many as two hundred and fifty-six policies using CIR, MBR, virtual-switching, and multicast-support shaping parameters. A typical TSCELL 1012 controls three levels of network hierarchy, e.g., as in FIG. 8. A single queue is implemented to preserve datapacket order, as in FIG. 9A. Such TSCELL 1012 is preferably self-contained with its on chip-based memory. The die size for such an IC is currently estimated at 2.00 square millimeters using 0.18 micron CMOS technology.

The output scheduler and marker 1014 schedules datapackets according to DiffServ Code Points and datapacket size. The use of a single queue is preferred. Marks are inserted according to parameters supplied by the TSCELL 1012, e.g., DiffServ Code Points. The die size for such an IC is currently estimated at 0.93 square millimeters using 0.18 micron CMOS technology.

The CPU 1016 is preferably implemented with an ARM740T core processor with 8K of cache memory. MIPS and POWER-PC are alternative choices. Cost here is a primary driver, and the performance requirements are modest. The die size for such an IC is currently estimated at 2.50 square millimeters using 0.18 micron CMOS technology. The control firmware supports four provisioning models: TFTP/Conf_file, simple network management protocol (SNMP), web-based, and dynamic. The TFTP/Conf_file provides for batch configuration and batch-usage parameter retrieval. The SNMP provides for policy provisioning and updates. User configurations can be accommodated by web-based methods. The dynamic provisioning includes auto-detection of connected devices, spoofing of current state of connected devices, and on-the-fly creation of policies.

In an auto-provisioning example, when a voice over IP (VoIP) service is enabled the protocol processor 1008 is set up to track SIP, or CQoS, or both. As the VoIP phone and the gateway server run the signaling protocol, the protocol processor 1008 extracts the IP-source, IP-destination, port-number, and other appropriate parameters. These are then passed to CPU 1016 which sets up the policy, and enables the classifier 1010, the TSCELL 1012, and the scheduler 1014, to deliver the service.

If the bandwidth management system 1000 were implemented as an application specific programmable processor (ASPP), the die size for such an IC is currently estimated at 105.72 square millimeters, at 100% utilization, using 0.18 micron CMOS technology. About one hundred and ninety-four pins would be needed on the device package. In a business model embodiment of the present invention, such an ASPP version of the bandwidth management system 1000 would be implemented and marketed as hardware description language (HDL) in semiconductor intellectual property (SIA) form, e.g., Verilog code.

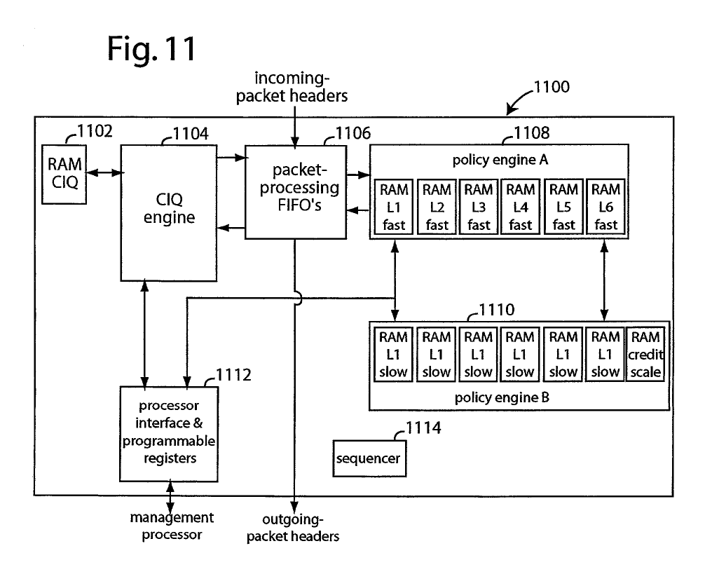

FIG. 11 represents a traffic shaping cell (TSCELL) 1100, in a semiconductor integrated circuit embodiment of the present invention. The TSCELL 1100 includes a random-access memory (RAM) classified-input queue (CIQ) 1102, a classified-input queue (CIQ) engine 1104, a set of datapacket-processing FIFO-registers 1106, a policy engine-A 1108 with fast RAM-memory, a policy engine-B 1110 with slow RAM-memory, a processor interface and programmable registers (PIF) 1112, and a sequencer (SEQ) 1114.

The CIQ engine 1104 services requests to initialize the RAM CIQ 1102 by clearing all the CIQ registers and CIQ-next pointers. It services requests to process the CIQ by traversing the CIQ, transferring data with the datapacket-processing FIFO-registers 1106, and supporting the add, delete, and mark-last linked-list operations. It further services SRAM access requests that come from the PIF 1112.

The policy engine-A 1108 services fast-variable RAM requests from the PIF 1112. It does limit checks for single datapackets in response to requests, e.g., in less than three clocks. The policy engine-A 1108 does distributed bandwidth adjustment, and credit replenishment for all nodes in response to requests, e.g., in 2*4K clocks. It implements an un-initialized policy interrupt. The policy engine-A 1108 controls the QueueCount Array during limit checking. The CIQ engine 1104 controls the QueueCount Array during credit replenishment.

The policy engine-B 1110 services slow-variable and scale factor RAM requests from the PIF 1112. It does limit checks for single datapackets in response to requests, e.g., in less than three clocks.

The SEQ 1114 includes functions for CIQ linked-list initialization, CIQ transversal, credit replenishment, and bandwidth adjustment. It further tracks tick-time, and provides an index into a scale-factor RAM for credit replenishment. The SEQ 1114 tracks the bandwidth adjustment period and periodically schedules re-initialization of a bandwidth adjustment algorithm.

The TSCELL 1100 can be manufactured, as described, by Taiwan Semiconductor Manufacturing Company (Hsinchu, Taiwan, Republic of China) using a 0.13 micron silicon process. An Artisan SAGE-X standard cell library can be used, with a MoSys or Virage RAM library for single-port synchronous RAM.

The following pseudocode is another way to describe how TSCELL 1100 can be constructed and how it functions. The pseudo-code is divided into (a) a main process, (b) CIQ processing, (c) input data processing, (d) policy checking, (e) credit replenishment, and (f) bandwidth adjustment. The pseudo-code for policy checking, credit replenishment, and bandwidth adjustment closely resembles a previous hardware implementation. The remaining pseudo-code differs substantially from such hardware implementation.

There is no pseudo-code for processing of multicast packet groups, specifically for “moving” the FIRST bit and LAST bit indicators between packets. When a packet that is marked FIRST_ONLY is released from the TSCELL, the FIRST bit in the subsequent packet of the multicast packet group should be set. When a packet that is marked LAST_ONLY is released from the TSCELL, the LAST bit in the previous packet of the multicast packet group should be set.

Main Process

void Main () {
// Start a parallel process for handling incoming packet
headers, fork ProcessInputData();
// LoopTimer is a free running timer that is cleared as
indicated!
// It is not a simple variable! LoopTimer = 0;
forever {

ProcessCIQ() ;
wait until (LoopTimer >= (4 * REFERENCE_LOOP_TIME));
ActualLoopTime = LoopTimer; LoopTimer = 0;
ReplenishCredit();
// Note: Only execute a portion of the
AdjustBandwidth() process. AdjustBandwidth();
} // end forever

} // end Main

CIQ Processing

// CIQ = Classified Input Queue
// LEVEL1 = Policy Memory Level 1
void ProcessCIQ() {
// Process the classified input queue PktPtr = HeadPtrCIQ;
LoopCount = CurrentNumberOf PacketsInCIQ; for (i = 0; 1 <
LoopCount; i++) {

// Memory Reads
PktHdr = CIQ [PktPtr] ;
PolDesc = LEVEL1 [PktHdr. Pol icyTag] ;
CheckingQueuedPacket = true;
CheckPolicy (

PolDesc,
PktHdr . PacketSize ,
PktHdr. Pol icyUpdateFlag,
CheckingQueuedPacket

);
if (PacketStatus == STATUS_0, 1, 2, 3, 4, 5)

SendPkt (PktHdr, PacketStatus);
RemoveFromListCIQ (PktPtr) ;

}
PktPtr = PktPtr.NextPtr;
} // end for

}
// end ProcessCIQ

Input Data Processing

// LEVEL1 = Policy Memory Level 1
//
// PacketGroupID[1:0] = 2′b10 = FIRST_ONLY
// PacketGroupID[1:0] = 2′b01 = LAST_ONLY
// PacketGroupID [1:0] = 2′b11 = FIRST_LAST
// PacketGroupID [1:0] = 2′b00 = MIDDLE
void ProcessInputData () {

forever {

if (NewPacketAvailable) {
// Format input data.
PktHdr = InputData;
if (CIQInProgress) {
// Perform limit checks on incoming packets.
// Memory Reads
PolDesc = LEVEL1 [PktHdr. PolicyTag] ;
CheckingQueuedPacket = false;
CheckPolicy (

PolDesc,
PktHdr.PacketSize
PktHdr .Pol icyUpdateFlag,
CheckingQueuedPacket

);
if (PacketStatus == STATUS_0,1,2,3,4,5,6,7,8,9) {

SendPkt (PktHdr, PacketStatus);
} else {
AddToListCIQ (PktHdr, CIQInProgress) ;

} else {

// DO NOT Perform limit checks on incoming

packets.

// (Just stuff them into the CIQ)
AddToListCIQ (PktHdr, CIQInProgress) ;
}

} // end forever }

} // end ProcessInputData
void AddToListCIQ (PktHdr, CIQInProgress) {

// Fiddle with pointers...
if (CIQInProgress) {

// No need to adjust QueueCount! It is already

taken care of by CheckPolicy!

} else {

LEVEL1 [PktHdr.PolicyTag].QueueCount++;

}

}
void RemoveFromListCIQ (PktPtr) {

// Fiddle with pointers...
// No need to adjust QueueCount! It is already taken

care of by CheckPolicy!
}

Policy Checking

// LEVEL1 = Policy Memory Level 1
// LEVEL2 = Policy Memory Level 2
// LEVEL3 = Policy Memory Level 3
// LEVEL4 = Policy Memory Level 4
// LEVEL5 = Policy Memory Level 5
// LEVEL6 = Policy Memory Level 6
//
// PD1 = Policy Descriptor Level 1
// PD2 = Policy Descriptor Level 2
// PD3 = Policy Descriptor Level 3
// PD4 = Policy Descriptor Level 4
// PD5 = Policy Descriptor Level 5
// PD6 = Policy Descriptor Level 6
boolean CheckPolicy(PolDesc, PacketSize, PolicyUpdateFlag,
CheckingQueuedPacket) {

PD1 = PolDesc;
// Memory Reads
PD2 = LEVEL2 [PD1.ParentTree.Level2ID];
PD3 = LEVEL5 [PD1.ParentTree.LevelSID];
PD4 = LEVEL4 [PD1.ParentTree.Level4ID];
PD5 = LEVEL5 [PD1.ParentTree.LevelSID];
PD6 = LEVEL5 [PD1.ParentTree.LevelSID];
PD1Init = PD1.Init
PD2Init = PD2.Init
PDSInit = PD3.Init
PD4Init = PD4.Init
PDSInit = PD5.Init
PD6Init = PDS.Init
PD2Valid = PD1.ParentTree.Level2Valid;
PDSValid = PD1.ParentTree.LevelSValid;
PD4Valid = PD1.ParentTree.Level4Valid;
PDSValid = PD1.ParentTree.LevelSValid;
PDSValid = PD1.ParentTree.LevelSValid;
PD1Check = PD1.ParentTree.Level1Check;
PD2Check = PD1.ParentTree.Level2Check;
PD3Check = PD1.ParentTree.LevelSCheck;
PD4Check = PD1.ParentTree.Level4Check;
PDSCheck = PD1.ParentTree.LevelSCheck;
PDSCheck = PD1.ParentTree.LevelSCheck;
PD1Update = PolicyUpdateFlag[0]
PD2Update = PolicyUpdateFlag[1]
PDSUpdate = PolicyUpdateFlag[2]
PD4Update = PolicyUpdateFlag[3]
PDSUpdate = PolicyUpdateFlag[4]
PDSUpdate = PolicyUpdateFlag[5]

No1nit = IPD1Init | !PD2Init | !PD3Init | !PD4Init
IPDSInit | IPDSInit;
Pass1 = IPD1Check ((PD1.SentPerTick +
PacketSize) < PD1.Credit)
Pass2 = !PD2Valid | !PD2Check | ((PD2.SentPerTick +
PacketSize) < PD2.Credit)
Pass3 = !PD3Valid !PD3Check j ((PD3.SentPerTick +
PacketSize) < PD3.Credit)
Pass4 = !PD4Valid !PD4Check ((PD4.SentPerTick +
PacketSize) < PD4.Credit)
PassS = !PD5Valid !PDSCheck ({PDS.SentPerTick +
PacketSize) < PD5.Credit)
Pass6 = IPDSValid !PD6Check j {(PDS.SentPerTick +
PacketSize) < PD6.Credit)
Pass = Pass1 & Pass2 & PassS & Pass4 & PassS & PassS;
Filter1 = PD1Check & PD1.ZeroCIR;
Filter2 = PD2Valid & PD2Check & PD2.ZeroCIR;
Filters = PDSValid & PDSCheck & PDS.ZeroCIR;
Filter4 = PD4Valid & PD4Check & PD4.ZeroCIR;
Filters = PDSValid & PDSCheck & PDS.ZeroCIR;
Filters = PDSValid & PDSCheck & PDS.ZeroCIR;
Filter = Filter1 | Filter2 Filters | Filter4 [ Filters |
Filters;
// In the hardware, there is an incoming pkt_op field with
specifies BYPASS,
// CHECK, or QUEUE. This routine does not accurately
reflect what happens when
// pkt_op equals QUEUE. The top-level algorithm reflects
“pkt_op==QUEUE” by showing
// that packets are unconditionally queued when
CIQInProgress is negated.
if (pkt_op==BYPASS) {

if (PacketGroupID == FIRST_LAST | LAST_ONLY) {

PacketStatus = STATUS_9;

} else {

PacketStatus = STATUS_8;

}

} elseif (pkt_op==QUEUE) {

if ((PD1.QueueCount == MAX_QUEUE_SIZE) CIQFull) {

if (PacketGroupID == FIRST_LAST) {

PacketStatus = STATUS_7;

} else {

PacketStatus = STATUS_5;

}

} else {

PD1.QueueCount++;
PacketStatus = STATUS_15;

}

} else {
/////////////////////////////////
//II Start of pkt_op==CHECK
/////////////////////////////////
if (NoInit) {

if (CheckingQueuedPacket) {

PD1.QueueCount−−;

}
TmpPacketStatus = STATUS_4_5;

} else {

if (CheckingQueuedPacket) {

////////////////////////////////////////////////////////
// Packet is from CIQ and Policies are initialized.
////////////////////////////////////////////////////////
// A queued packet can only be sent forward if it is
// the FIRST packet in the LI queue.
if (PD1.QueueFirst == 1) {

switch (Pass, Filter) {

case (T,F): { TmpPacketStatus = STATUS_0_1;

PD1.QueueCount−−;

}

case (-,T): { TmpPacketStatus = STATUS_2_3;

PD1.QueueCount−−;

}

case (F,F): { TmpPacketStatus = STATUS_15;

PD1.QueueFirst =0;

}

}

} else {

TmpPacketStatus = STATUS_15;

}

} else {

////////////////////////////////////////////////////
//Packet is from INPUT and policies are initialized.
////////////////////////////////////////////////////
//An input packet can only be sent forward if there are

// no packets in the LI queue.
if (PD1.QueueCount == 0) {

switch (Pass, Filter) {

case (T,F): { TmpPacketStatus = STATUS_0_1;

}

case (-,T): { TmpPacketStatus = STATUS_2_3;

}

case (F,F): { if (CIQFUll) {

TmpPacketStatus = STATUS_6_7;

} else {

TmpPacketStatus = STATUS_15;
PD1.QueueCount++;

}

}

} else if ((PD1.QueueCount == MAX_QUEUE_SIZE) CIQFull)

{

TmpPacketStatus = STATUS_6_7;

} else {

TmpPacketStatus = STATUS_15;
PD1.QueueCount++;

}

if (PacketGroupID == FIRST_LAST) {

switch (TmpPacketStatus){

case STATUS_0_1 : PacketStatus = STATUS_1;
case STATUS_2_3 : PacketStatus = STATUS_3;
case STATUS_4_5 : PacketStatus = STATUS_5;
case STATUS_6_7 : PacketStatus = STATUS_7;
case STATUS_15 : PacketStatus = STATUS_15;

}

} else { // FIRST_ONLY MIDDLE LAST_ONLY

switch (TmpPacketStatus) {

case STATUS_0_1 : PacketStatus = STATUS_0;
case STATUS_2_3 : PacketStatus = STATUS_2;
case STATUS_4_5 : PacketStatus = STATUS_4;
case STATUS_6_7 : PacketStatus = STATUS_6;
case STATUS_15 : PacketStatus = STATUS_15;

}

}

PD1.ActivityTimer = MAX_ACTIVITY;
// PD2.ActivityTimer = MAX_ACTIVITY; // Subscriber nodes

do not have this variable

PD3.ActivityTimer = MAX_ACTIVITY;
PD4.ActivityTimer = MAX_ACTIVITY;
PD5.ActivityTimer = MAX_ACTIVITY;
PD6.ActivityTimer = MAX_ACTIVITY;

} // end of (No1nit) else code
// Perform calculations for packet that pass limit checks.
if (PacketStatus == STATUS_0 STATUS_1) {

if (PD1Update) {

PD1.SentPerTick += PacketSize;
PD1.Credit −= PacketSize;

}
if (PD2Update) {

PD2.SentPerTick += PacketSize;
PD2.Credit −= PacketSize;

}
if (PDBUpdate) {

PD3.SentPerTick += PacketSize;
PD3.Credit −= PacketSize;

}
if (PD4update) {

PD4.SentPerTick += PacketSize;
PD4.Credit −= PacketSize;

}
if (PDSUpdate) {

PD5.SentPerTick += PacketSize;
PD5.Credit −= PacketSize;

}
if (PDSUpdate) {

PD6.SentPerTick += PacketSize;
PD6.Credit −= PacketSize;

}

}
// Update policies
// Memory Writes
LEVEL1 [PktHdr.Policy-Tag] = PD1
LEVEL2 [PD1.ParentTree.Level11D] = PD2
LEVEL3 [PD1.ParentTree.Level2ID] = PD3
LEVEL4 [PD1.ParentTree.LevelsID] = PD4
LEVEL5 [PDi.ParentTree.Level4ID] = PD5
LEVEL5 [PD1.ParentTree.LevelBID] = PD6
return (PacketStatus);

}

Credit Replenishment

// LEVEL1 = Policy Memory Level 1
// LEVEL2 = Policy Memory Level 2
// LEVEL5 = Policy Memory Level 3
// LEVEL4 = Policy Memory Level 4
// LEVEL5 = Policy Memory Level 5
// LEVEL6 = Policy Memory Level 6
//
// PD1 = Policy Descriptor Level 1
// PD2 = Policy Descriptor Level 2
// PD3 = Policy Descriptor Level 3
// PD4 = Policy Descriptor Level 4
// PD5 = Policy Descriptor Level 5
// PD6 = Policy Descriptor Level 6
void ReplenishCredit () {
// ScaleArray contains scaling factors according to ratio of
// ActualLoopTime to REF_LOOP.
Scale = ScaleArray [ (ActualLoopTime div REF_LOOP)];
// Important Note!
// All of the following operations can be performed in
parallel!
// There are no data dependencies that limit
parallelization!
// Level 1
for (i =0; i < 20,480; i++) {
PD = LEVEL1[i];
PD.Credit = mint (PD.Credit + Scale*PD.Boost), PD.MaxCredit
);
PD.SentPerAdj += PD.SentPerTick;
PD.SentPerTick = 0;
PD.QueueFirst = 1;
LEVEL1[i] = PD;
}
// Level 2
for (i = 0; i < 5,120; i++) {
PD = LEVEL2 [i];
PD.Credit. = mint (PD.Credit + Scale*PD.Boost), PD.MaxCredit
);
PD.SentPerAdj += PD.SentPerTick;
PD.SentPerTick = 0;
LEVEL2[i] = PD;
}
// Level 3
for (i = 0; i < 64; i++) { PD = LEVEL5 [i] ;
PD.Credit = min ( (PD.Credit + Scale*PD.Boost) ,
PD.MaxCredit ) ; PD.SentPerAdj += PD.SentPerTick;
PD.SentPerTick = 0; LEVEL5 [i] = PD;
}
// Level 4
for (i = 0; i < 64;
PD = LEVEL4 [i];
PD.Credit = min(
(PD.Credit + Scale*PD.Boost), PD.MaxCredit )
PD.SentPerAdj += PD.SentPerTick;
0;
PD.SentPerTick = LEVEL4[i] = PD;
// Level 5
for (i = 0; i < 128; i++)
PD = LEVEL5 [i];
(PD.Credit + Scale*PD.Boost), PD.MaxCredit ) PD.SentPerTick;
PD.Credit = mint
PD.SentPerAdj +=
PD.SentPerTick =
LEVEL5[i] = PD;
//
// Level 6
for (i = 0; i < 64;
PD = LEVEL6[i];
PD.Credit = min((PD.Credit + Scale*PD.Boost), PD.MaxCredit
0;
PD.SentPerAdj += PD.SentPerTick, o
PD.SentPerTick = LEVEL5[i] = PD;

}

}

“TickTime” refers to the time required to, traverse the entire CIQ, perform Credit Replenishment for all nodes, and do the Bandwidth Adjustment for a portion of the nodes. REFJLOOP is a programmable timer used to signal a 25 us period. The minimum TickTime is enforced, e.g., to (4×REF_LOOP) microseconds, or 100 us. The maximum TickTime is 10-milliseconds. Actual TickTime is somewhere in between.

The ratio of actual TickTime to minimum TickTime is in the range of Ix-lOOx, with a resolution of the ratio being 0.25. The ratio is a fixed point number of the format N:M, where N is 8 (supporting a 256x range), and M is 2 (supporting a 0.25 granularity).

REF_LOOP_TOTAL is used to measure actual TickTime. REF_LOOP_TOTAL is incremented every time that REF_LOOP overflows. REF_LOOP_TOTAL provides the above mentioned ratio in the above mentioned fixed point format. REF_LOOP TOTAL is 10 bits in size. REFJLOOP JTOTAL is used to index an array that contains values used for scaling boost during credit replenishment.

For linear scaling, the array is loaded as follows,

| Array Index | Array Data | (Fixed Point Format of |
|---|---|---|
| 0 | (not applicable | to minimum TickTime) |
| 1 | (not applicable | to minimum TickTime) |
| 2 | (not applicable | to minimum TickTime) |
| 3 | (not applicable | to minimum TickTime) |
| 4 | 1.0 (scale boost | 1.00x) |
| 5 | 1.1 (scale boost | 1.25x) |
| 6 | 1.2 (scale boost | 1.50x) |
| 7 | 1.3 (scale boost | 1.75x) |
| 8 | 2.0 (scale boost | 2.00x) |
| 9 | 2.1 (scale boost | 2.25x) |
| 10 | 2.2 (scale boost | 2.50x) |
| 11 | 2.3 (scale boost | 2.75x) |

Bandwidth Adjustment

// LEVEL1 = Policy Memory Level 1
// LEVEL2 = Policy Memory Level 2
// LEVEL5 = Policy Memory Level 3
// LEVEL4 = Policy Memory Level 4
// LEVEL5 = Policy Memory Level 5
// LEVEL6 = Policy Memory Level 6
void AdjustBandwidth 0 {
// Each bit in these arrays corresponds to a specific node's
Attack bit. reg [63:0] AttackLevele;
reg [127:0] AttackLevelS;
reg [63:0] AttackLevel4;
reg [63:0] AttackLevelS;
AttackLevel6 = 0; o ,
AttackLevelS = 0;
AttackLevel4 = 0
AttackLevelS = 0
// Note
// In the hardware, the bandwidth adjustment algorithms for
// Level 6 thru Level 3 will be identical.
// Nodes can be programmed to produce the behavior
// described in Ray's algorithm by setting CIR=MBR.
// The tests for this condition also aid in system
initialization.
// Level 6
for (i = 0; i < 64; i ++) {

PD = LEVEL6 [i] ;

// ParentOK = true;

NodeOK = (PD.SentPerAdj < (PD.Capacity - PD.Margin));

// If (ParentOK & NodeOK) {

AttackLevels [i] = 1;

}

// if ((PD.ActivityTimer==0) (PD,CIR==PD.MBR)) {

PD.Boost = PD.CIR;

} else {

if (ParentOK & NodeOK) {

PD.Boost = min( (PD.Boost + PD.Attack), PD.MBR )

} else {

PD.Boost = max( (PD.Boost - PD.Retreat), PD.CIR )

}

}

// PD.SentPerAdj = 0;

if (PD.ActivityTimer != 0) {

PD.ActivityTimer−−;

}
LEVEL6[i] = PD;

}
//
// Level 5
for (i = C; i < 128; i + +) {

PD = LEVEL5 [i];
// ParentOK = ((PD.ParentMask & !AttackLevelS) == 0);
NodeOK = (PD.SentPerAdj < (PD.Capacity - PD.Margin)) ;

// if (ParentOK & NodeOK) {

AttackLevelS [i] = 1;

}

// if ((PD.ActivityTimer==0) | (PD.CIR==PD.MBR)) {

PD.Boost = PD.CIR;

} else {

if (ParentOK & NodeOK) {

PD.Boost = min( (PD.Boost + PD.Attack), PD.MBR )

} else {

PD.Boost. = max( (PD.Boost - PD.Retreat), PD.CIR )

}

}

// PD.SentPerAdj = 0;

if (PD.ActivityTimer != 0) {

PD.ActivityTimer−−;

}
LEVEL5 [i] == PD;

}
// Level 4
for (i = 0; i < 64; i++) {

PD = LEVEL4 [i] ;

// ParentOK = ((PD.ParentMask & !AttackLevelS) == 0);

NodeOK = (PD.SentPerAdj < (PD.Capacity - PD.Margin));

// if (ParentOK & NodeOK) {

AttackLevel4[i] = 1;

}

// if ((PD.ActivityTimer==0) | (PD.CIR==PD.MBR)) {

PD.Boost = PD.CIR;

} else {

if (ParentOK & NodeOK) {

PD.Boost = min( (PD.Boost + PD.Attack), PD.MBR )

} else {

PD.Boost = max( (PD.Boost − PD.Retreat), PD.CIR )

}

}

// PD.SentPerAdj = 0;

if (PD.ActivityTimer != 0) {

PD.ActivityTimer−−;

}
LEVEL4[i] = PD;

}
//
// Level 3
for (i = 0; i < 64; i++) {

PD = LEVEL5[i];

// ParentOK = ((PD.ParentMask & !AttackLevel4) == 0);

NodeOK = (PD.SentPerAdj < (PD.Capacity - PD.Margin));

// If (ParentOK & NodeOK) {

AttackLevelS[i] = 1;

}

// if ((PD.ActivityTimer==0) | (PD.CIR==PD.MBR)) {

PD.Boost = PD.CIR;

} else {

if (ParentOK & NodeOK) {

PD.Boost = min( (PD.Boost + PD.Attack), PD.MBR )

} else {

PD.Boost = max( (PD.Boost − PD.Retreat), PD.CIR )

}

//

PD.SentPerAdj = 0;
if (PD.ActivityTimer != 0) {

PD.ActivityTimer−−;

}
LEVEL5[i] = PD;

}
// Level 2
for (i = 0; i < 5,120; i++) {

PD = LEVEL2 [i] ;

// ParentOK = ((PD.ParentMask & !AttackLevelS) == 0);

NodeOK = (PD.SentPerAdj < (PD.Capacity - PD.Margin));

// If (ParentOK & NodeOK) {

PD.Attack = 1;

}

//
// The Level 2 nodes are a bit different from the other
// hierarchical nodes in that these nodes are truly
// de-functioned. Read on...
// The hardware provides capability for Level 6 thru Level 3
nodes
// to support bursting operation. This is essentially “free”
due
// to the limited number of these nodes, and may be of
actual use.
//
// On the other hand, the hardware will not support bursting
// Level 2 nodes. This is too “expensive” to implement due
// to the large number of Level 2 nodes.
//
// That's why this code is unlike that of the Level 6 thru
Level 3 nodes.
// (ie, no adjustable Boost and no Activity Timer)
// The following operation is performed so that credit
updates will
// always reflect current policy information.

PD.Boost = PD.CIR;
PD.SentPerAdj = 0;
LEVEL2[i] = PD;

}
// User
for (i = 0; i < 20,480; i++) {

PD = LEVEL1 [i] ;
ParentPD = LEVEL2 [PD.ParentTree.Level2ID] o

// ParentOK = (ParentPD.Attack == 1);
// if ((PD.ActivityTimer==0) | (PD.CIR==PD.MBR)) {

PD.Boost = PD.CIR;

} else {

if (ParentOK) {

PD.Boost = min( (PD.Boost + PD.Attack), PD.MBR )

} else {

PD.Boost = max( (PD.Boost − PD.Retreat), PD.CIR )

}

PD.SentPerLog += PD.SentPerAdj;
PD.SentPerAdj = 0 ;
if (PD.ActivityTimer != 0) {

PD.ActivityTimer−−;
}

LEVEL1[i] = PD;

}

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. A semiconductor integrated circuit chip for managing the distribution of network datapackets, comprising:
a service-level agreement policy that limits allowable bandwidths to particular nodes in a hierarchical network;
a classified-input queue for classifying datapackets moving through said hierarchical network according to a particular service-level agreement policy;
a buffer for delaying any said datapackets in a buffer to enforce said service-level agreement policy;
a linked-list for maintaining a statistic for each said particular service-level agreement policy related to how many said datapackets are in said buffer at any one instant;
a processor for sending any newly arriving datapackets to said buffer simply if a corresponding service-level agreement policy statistic indicates any other earlier arriving datapackets related to the same service-level agreement policy are currently being buffered; and
a sequencer for managing all datapackets moving through said hierarchical network from a queue in which each entry includes service-level agreement policy bandwidth allowances for every hierarchical node in said network through which a corresponding datapacket must pass.

2. The chip of claim 1, further comprising:
a processor for testing in parallel whether a particular datapacket should be delayed in a buffer or sent along for every hierarchical node in said network through which it must pass.

3. The chip of claim 1, further comprising:
a processor for constructing a single queue of entries associated with corresponding datapackets passing through said hierarchical network such that each entry includes source and destination header information and any available bandwidth credits for every hierarchical node in said network through which a corresponding datapacket must pass.

4. A network bandwidth traffic-shaping cell for managing the distribution of datapackets, comprising:
a processor for associating a service-level agreement policy that limits allowable bandwidths to particular nodes in a hierarchical network;
means for classifying datapackets moving through said hierarchical network according to a particular service-level agreement policy;
means for delaying any said datapackets in a buffer to enforce said service-level agreement policy;
means for maintaining a statistic for each said particular service-level agreement policy related to how many said datapackets are in said buffer at any one instant;
means for sending any newly arriving datapackets to said buffer simply if a corresponding service-level agreement policy statistic indicates any other earlier arriving datapackets related to the same service-level agreement policy are currently being buffered; and
means for managing all datapackets moving through said hierarchical network from a queue in which each entry includes service-level agreement policy bandwidth allowances for every hierarchical node in said network through which a corresponding datapacket must pass.

5. The means of claim 4, further comprising:
means for testing in parallel whether a particular datapacket should be delayed in a buffer or sent along for every hierarchical node in said network through which it must pass.

6. The means of claim 4, further comprising:
means for constructing a single queue of entries associated with corresponding datapackets passing through said hierarchical network such that each entry includes source and destination header information and any available bandwidth credits for every hierarchical node in said network through which a corresponding datapacket must pass.

7. A traffic-shaping cell providing for an inspection of each one of said individual entries and for outputting a single decision whether to pass through or buffer each of said datapackets in all network nodes through which each must pass, wherein, datapackets in a buffer are delayed to enforce a service-level agreement policy, and a statistic is maintained for each said particular service-level agreement policy related to how many datapackets are in a buffer at any one instant, and any newly arriving datapackets are sent to said buffer simply if a corresponding service-level agreement policy statistic indicates any other earlier arriving datapackets related to the same service-level agreement policy are currently being buffered, and all datapackets moving through a hierarchical network are controlled such that each entry includes service-level agreement policy bandwidth allowances for every hierarchical node in said network through which a corresponding datapacket must pass.

8. The system of claim 7, wherein:
the traffic-shaping cell is implemented as a semiconductor intellectual property and operate at run-time with the single queue.
